(19) United States
(12) Patent Application Publication
(10) Pub. No.: US 2009/0277181 A1
(43) Pub. Date: Nov. 12, 2009

(54) AIRCRAFT PROPULSION UNIT THAT COMPRISES AN EXHAUST PIPE WITH A SCALLOPED TRAILING EDGE

(75) Inventors: Yann Druon, Toulouse (FR); Frederic Chelin, Encausse (FR); Fabrice Gantie, Toulouse (FR)

Correspondence Address: YOUNG & THOMPSON, 209 Madison Street, Suite 500, ALEXANDRIA, VA, 22314, US

(73) Assignee: AIRBUS FRANCE, SOCIETE PAR ACTIONS SIMPLIFIEE, Toulouse (FR)

(21) Appl. No.: 12/305,558

(22) PCT Filed: Jun. 13, 2007
(86) PCT No.: PCT/FR07/51434

§ 371 Date: Jun. 18, 2009

(30) Foreign Application Priority Data
Jun. 21, 2006 (FR) 0605546

(51) Int. Cl. F02K 1/00

(52) U.S. Cl. 60/770

(57) ABSTRACT

A propulsion unit includes at least one exhaust pipe (62, 76) that includes an air discharge that is delimited by a trailing edge (78, 82). The end part of the exhaust pipe (62, 76) includes two scalloped shapes (84) that each correspond to a preferred acoustic radiation direction, separated by advanced parts (86) that can limit the acoustic radiation, whereby the scalloped shapes are offset upward relative to the horizontal median plane.

This invention relates to an aircraft propulsion unit that comprises an exhaust pipe with a scalloped trailing edge.

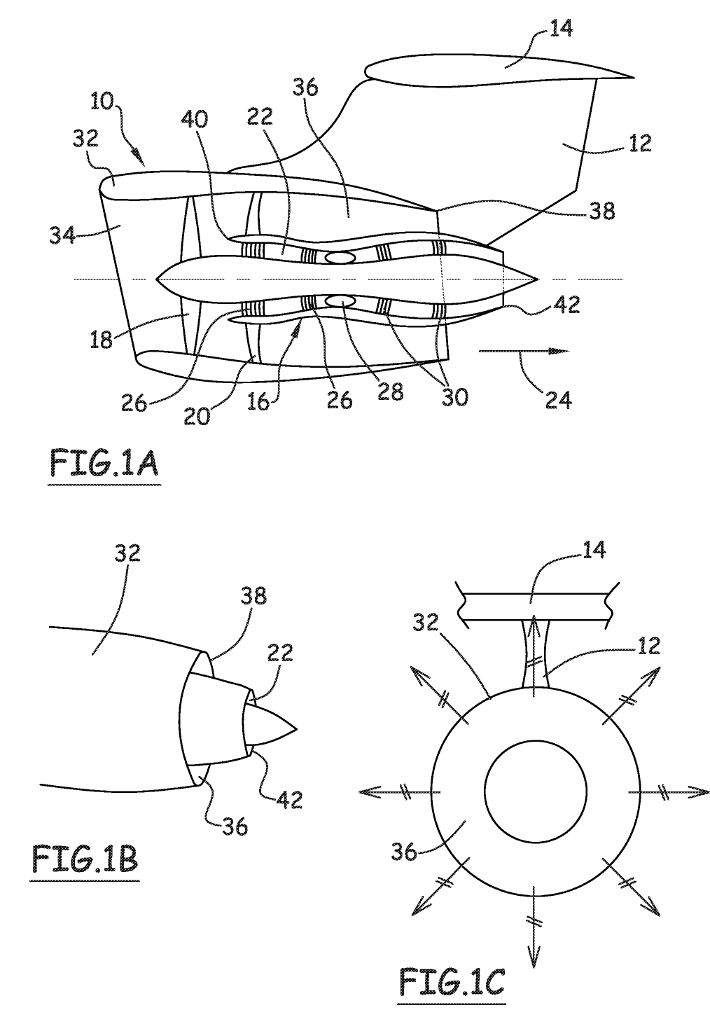

FIG. 1A shows at 10 an aircraft propulsion unit, also called a turbojet, connected to an aircraft using connecting means, in particular using a pole 12 under the wing 14. It comprises an engine 16 with, on the one hand, a fan that comprises a rotor 18 that is equipped with blades and a stator 20 that is equipped with paddles, and, on the other hand, a primary pipe 22 in which are arranged, according to the direction of the flow of the air 24, compressor stages 26, a combustion chamber 28, and turbine stages 30. The engine 16 is arranged in a nacelle 32 that comprises an air intake 34 upstream from the fan and a secondary pipe 36 downstream from the stator of the fan.

Downstream, the secondary pipe 36 comprises a so-called secondary trailing edge 38 delimiting an air discharge.

In the same way, the primary pipe 22 comprises a so-called primary leading edge 40 that delimits the air intake upstream from the compressor stages 26 and a so-called primary trailing edge 42 that delimits the exhaust gas discharge downstream from the turbine stages 30.

The primary trailing edge 42 and secondary trailing edge 38 are each arranged in an essentially vertical plane.

Based on power plants, the primary pipe 22 can extend beyond the secondary trailing edge 38, behind the nacelle 32.

The noise that is emitted by the propulsion unit 10 consists of, on the one hand, jet noise, produced on the outside of the pipes following the mixing of different flows, and, on the other hand, noise from internal parts, called internal noise, produced by the fan, the compressors, the turbines, and the combustion that propagates inside the pipes.

To limit the impact of noise pollution near airports, the international standards are increasingly restrictive as far as sound emissions are concerned.

Techniques have been developed to reduce internal noise, in particular by arranging, at pipe walls, coatings that are intended to absorb a portion of the sound energy, in particular by using the principle of Helmholtz resonators.

The internal noise, however, which consists primarily of noise from the fan and a large portion of which propagates into the secondary pipe and radiates upon exiting the pipe, remains a predominant noise source, despite the use of acoustic coatings.

Also, to limit the acoustic radiation of the exhaust pipes, a first solution consists in providing a secondary pipe 36 that ends in a bevel shape so as to direct the emission of the noise upward and thus to limit the radiation of said noise toward the ground. According to this solution, the secondary trailing edge 38 is arranged in an inclined plane, whereby the top part of the pipe is offset upstream relative to the bottom part.

This embodiment is described in particular in the document U.S. 2004/0140397 that deals more particularly with aerodynamic problems. According to certain embodiments that are described, the exhaust pipe comprises two parts, a primary stationary part and a beveled end part that can pivot around the shaft of the pipe relative to the stationary part so as to direct the ejected air flow based on the desired path. According to certain positions, the air flow can be ejected toward one side.

Even if this document suggests a reduction in noise by directing the air flow upward, this solution is not satisfactory for the following reasons: The orientation of the air flow that ends in a bevel shape (trailing edge arranged in a plane) is not optimum because the radiation is directed toward a zone of too large a space, corresponding to a half-space. Also, even when the flow is directed toward the side, a significant portion of the noise is directed toward the ground.

When the propulsion unit is arranged under the wing (most common assembly), if the air flow is ejected upward, it is reflected toward the ground by the wing. This solution emphasizes the problem since the acoustic radiation that is preferably directed upward is reflected by the wing toward the ground.

To limit the influence of the reflection of the wing in the direction of the ground, a solution that is described in the document EP-1,493,665 provides a particular profile of the lower surface of the wing so that the acoustic waves are preferably reflected in the direction of the hot jet that exits from the primary pipe. Thus, the turbulent and unstable flows of the hot jet are able to disperse a portion of the acoustic energy.

Nevertheless, this solution is not satisfactory, because it is generally expensive and imposes an additional constraint on the profile of the wing that may be antinomic with the primary constraints, namely the mechanical strength and the aerodynamic constraints such as lift or drag.

Also, the object of this invention is to eliminate the drawbacks of the prior art by proposing a form of exhaust pipe of simple and effective design, making it possible to limit the inside noise of the engine, in particular the fan noise, the turbine noise and the combustion noise.

For this purpose, the invention has as its object a propulsion unit that comprises at least one exhaust pipe that comprises an air discharge that is delimited by a trailing edge, characterized in that the end part of the exhaust pipe comprises two scalloped shapes that each correspond to a preferred acoustic radiation direction, separated by advanced parts that can limit the acoustic radiation, whereby said scalloped shapes are offset upward relative to the horizontal median plane.

Thus, the scalloping or scalloped shapes are arranged so as not to direct the acoustic radiation downward or in the direction of a part of the aircraft that can reflect it in the direction of the ground.

Other characteristics and advantages will emerge from the following description of the invention, a description that is provided only by way of example, with regard to the accompanying drawings, in which:

FIG. 1A is a longitudinal cutaway along a vertical plane of a propulsion unit according to the prior art,

FIG. 1B is a perspective view of the rear of the propulsion unit of FIG. 1A,

FIG. 1C is a rear view of the propulsion unit of FIG. 1A indicating the orientation of the acoustic radiation,

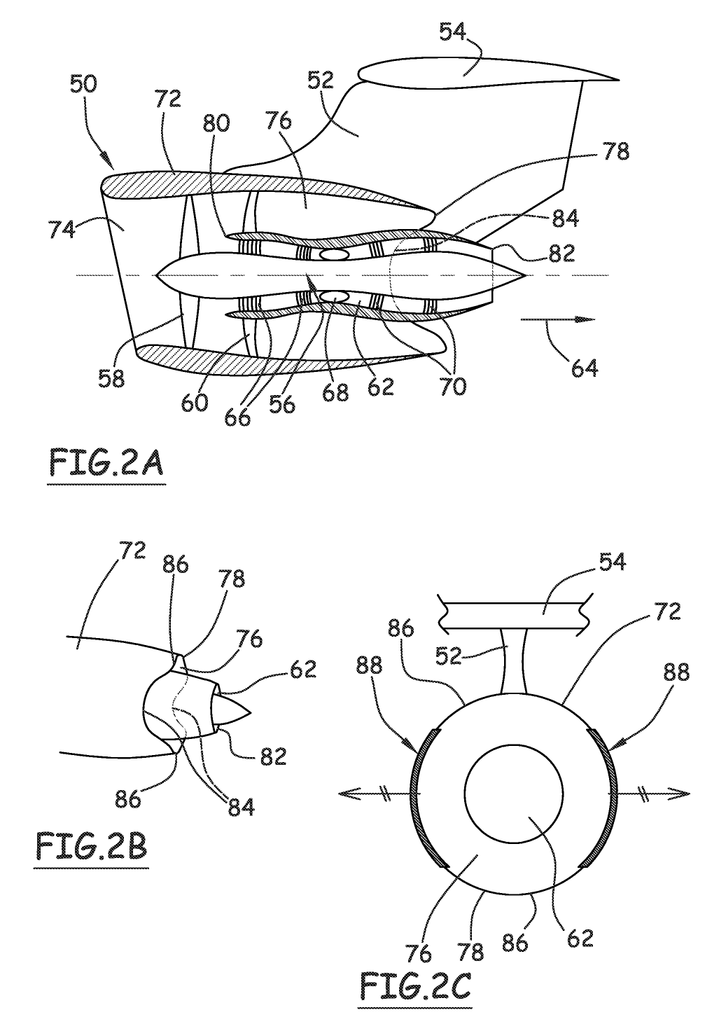

FIG. 2A is a longitudinal cutaway along a vertical plane of a propulsion unit according to the invention,

FIG. 2B is a perspective view of the rear of the propulsion unit of FIG. 2A,

FIG. 2C is a rear view of the propulsion unit of FIG. 2A that indicates the orientation of the acoustic radiation,

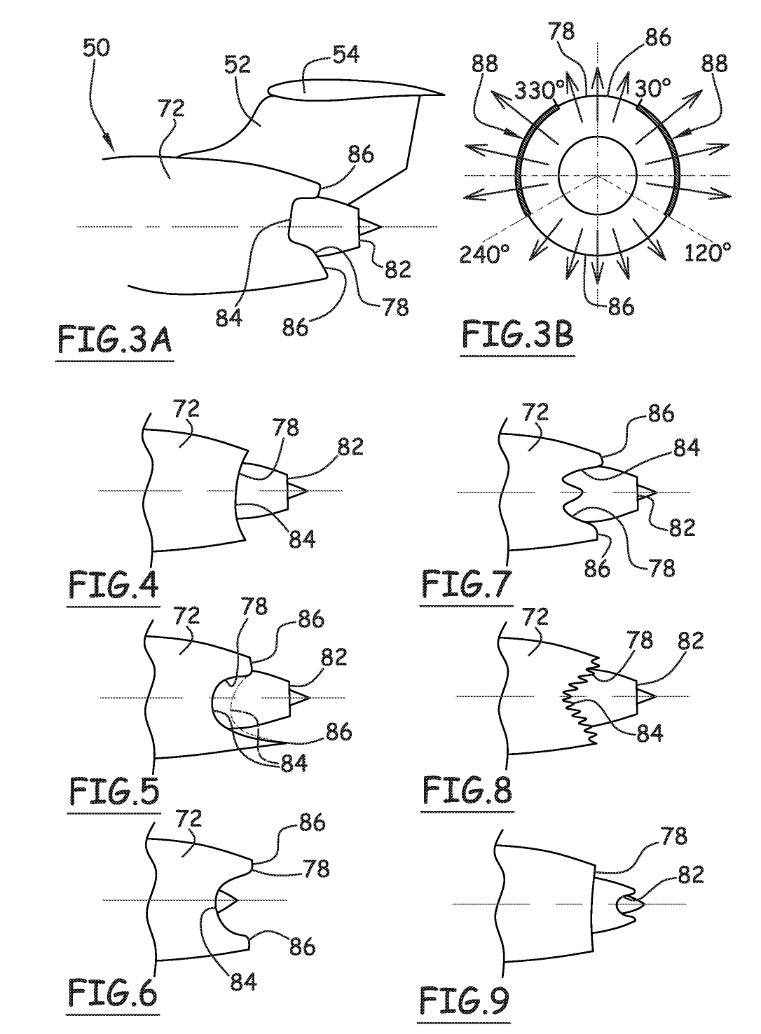

FIG. 3A is a side view of a propulsion unit according to a preferred embodiment of the invention,

FIG. 3B is a rear view of the propulsion unit of FIG. 3A that indicates the orientation of the acoustic radiation, and

FIGS. 4 to 9 are side views of a propulsion unit according to different variants of the invention.

In FIG. 2A, an aircraft propulsion unit, also called a turbojet, connected using connecting means to an aircraft, in particular using a pole 52 under the wing 54 of the aircraft, was shown at 50.

The invention, however, is not limited to this implantation, whereby the propulsion unit can be connected to another part of the aircraft by means of different connecting means.

According to an embodiment, the propulsion unit 50 comprises, on the one hand, an engine 56 with, on the one hand, a fan that comprises a rotor 58 that is equipped with blades and a stator 60 that is equipped with paddles, and, on the other hand, a primary pipe 62 in which compressor stages 66, a combustion chamber 68, and turbine stages 70 are arranged according to the direction of flow of the air 64. The engine 56 is arranged in a nacelle 72 that comprises an air intake 74 upstream from the fan and a secondary pipe 76 downstream from the stator 60 of the fan.

The secondary pipe 76 comprises, downstream, a so-called secondary trailing edge 78 that delimits an air discharge.

The primary pipe 62 comprises a so-called primary leading edge 80 that delimits the air intake upstream from the compressor stages 66 and a so-called primary trailing edge 82 that delimits the discharge of exhaust gases downstream from the turbine stages 70.

Based on the power plants, the primary pipe 62 can extend beyond the secondary trailing edge 78, at the rear of the nacelle 72, as illustrated in FIGS. 2A, 3A, 4, 5, and 7 to 9, or does not exceed the secondary trailing edge 78 as illustrated in FIG. 6.

The interaction of the air flow with the fan produces a noise that is called fan noise that is then propagated in the secondary exhaust pipe, but also in the air intake, and that then radiates in all directions upon exiting said pipe according to the prior art.

In the same way, the interaction of the flow with the turbine stages produces a noise that propagates into the primary exhaust pipe and radiates upon exiting in all of the directions according to the prior art.

The object of the invention is more particularly to reduce the perception of engine noise on the ground, in particular the fan noise, the turbine noise, the combustion noise, emitted by a propulsion unit that comprises at least one exhaust pipe.

It is described applied to the secondary pipe 76 but can also be applied to the primary pipe 62 as illustrated in FIG. 9.

According to the invention, the terminal part of the exhaust pipe 76 comprises two scalloped shapes 84 that each correspond to a preferred acoustic radiation direction, separated by advanced parts 86 that can limit the acoustic radiation, whereby said scalloped shapes 84 are offset upward relative to the horizontal median plane.

This solution makes it possible to obtain a trailing edge 78 that is not arranged in a plane, whereby the scalloping corresponds to a preferred acoustic radiation direction.

Unlike a beveling of the pipe, the scalloping makes it possible to better channel the acoustic radiation along at least one zone of the space that is more restricted than a half-space.

Scalloping is defined as a cutting in the end part of the pipe that corresponds to the line of intersection between the surface that defines the pipe and a non-plane surface.

According to a first embodiment that is illustrated in FIGS. 2A, 2B and 2C, when the propulsion unit 50 is arranged under the wing, the trailing edge 78 comprises two advanced parts 86, above and below, which are arranged in a plane and two scalloped portions 84 on the left and right sides of the pipe. Thus, the exhaust pipe comprises two “openings” 88 on the sides, indicated by thick lines in FIG. 2C, promoting a lateral radiation. In addition, the advanced parts 86 make it possible to partially mask the radiation in the vertical directions, downward and upward.

According to a preferred embodiment that is illustrated in FIGS. 3A and 3B, the scalloped portions 84 are offset upward relative to the horizontal medium plane, so as to extend, as illustrated in FIG. 3B, for the first scalloping over an angular sector that ranges approximately from 30° to 120° and for the second scalloping from 240° to 330°. The angular values that are indicated are in no way limiting. The positions of the scalloped portions 84 are determined so as to ensure a reduction of the acoustic radiation in the direction of the ground but also in the direction of the so-called lateral certification point located in a plane at 56° of the vertical plane.

In this configuration, the advanced part above is smaller than the advanced part below. Nevertheless, this advanced part above is not zero and extends over an angle on the order of 60° so as to limit the radiation toward the wing to limit the reflection of acoustic waves.

Advantageously, the scalloped shapes are arranged essentially symmetrically relative to a vertical median plane.

The invention is not limited to this embodiment. Thus, the exhaust pipe may comprise a single scalloping when the propulsion unit is added directly to the fuselage, or several scalloped shapes so as to define preferred directions of acoustic radiation, one for each scalloping.

Thus, the scalloped shapes are arranged so as not to direct the acoustic radiation downward or in the direction of a part of the aircraft that can reflect it in the direction of the ground.

As indicated above, in the case of a propulsion unit 50 with a short nacelle, the invention may be applied to primary exhaust pipes 62 and/or secondary exhaust pipes 76. In the case of a long nacelle, as illustrated in FIG. 6, the production of a scalloping 84 according to the invention offers an advantage only on the level of the secondary pipe 76.

Various arrangements and shapes can be considered for the scalloped shapes.

Thus, as illustrated in FIG. 4, the exhaust pipe can comprise at least two scalloped shapes that extend over the entire length of the trailing edge 78, in this case two scalloped shapes 84 that can be joined at a first point located on the upper generatrix of the pipe and at a second point located on the lower generatrix of the pipe.

According to an embodiment that is illustrated in FIG. 5, the scalloped shapes cannot be symmetrical along a vertical median plane and/or a horizontal median plane. Likewise, the advanced part below can be longer than the advanced part above or vice versa.

According to the variants, the scalloping 84 can have different shapes. Thus, it can be arc-shaped as illustrated in FIGS. 2A, 4, 5, 6 or 9, or it can have a shape with V-shaped patterns as illustrated in FIG. 8, or it can consist of a succession of curved lines as illustrated in FIG. 7. Finally, as illustrated in FIG. 3A, the scalloping can comprise curved portions and essentially rectilinear portions.

The specific shape of the scalloping or scalloped shapes is adapted based on each propulsion unit/aircraft pair. Thus, the distance in the axial direction between the point furthest upstream and the point furthest downstream of the trailing edge, corresponding to the depth of the scalloping, the angular distance over which the scalloping extends as well as the angular position of the scalloping are adjusted so as to obtain the best compromise between the acoustic gain perceived on the ground and the performance levels of the propulsion unit and the aircraft, in particular as far as thrust and aerodynamics are concerned.

1. Propulsion unit that comprises at least one exhaust pipe (62, 76) that comprises an air discharge that is delimited by a trailing edge (78, 82), characterized in that the end part of the exhaust pipe (62, 76) comprises two scalloped shapes (84) that each correspond to a preferred acoustic radiation direction, separated by advanced parts (86) that can limit the acoustic radiation, whereby said scalloped shapes are offset upward relative to the horizontal median plane.

2. Propulsion unit according to claim 1, wherein the scalloped shapes (84) are arranged symmetrically relative to a vertical median plane.

3. Propulsion unit according to claim 2, wherein a first scalloping extends over an angular sector that ranges from approximately 30° to 120° and wherein the second scalloping extends over an angular sector that ranges approximately from 240° to 330°.

4. Propulsion unit that comprises, on the one hand, an engine (56) that comprises a fan (58) and a primary pipe (62), and, on the other hand, a nacelle (72) that delimits a secondary pipe (76) that comprises downstream, according to the directions of air flow, a trailing edge (78) that delimits an air discharge, wherein the terminal part of the secondary pipe (76) comprises two scalloped shapes (84) that each correspond to a preferred acoustic radiation direction, separated by advanced parts (86) that can limit the acoustic radiation, whereby said scalloped shapes are offset upward relative to the horizontal median plane.

5. Propulsion unit according to claim 4, wherein the scalloped shapes (84) are arranged symmetrically relative to a vertical median plane.

6. Propulsion unit according to claim 5, wherein a first scalloping extends over an angular sector that ranges approximately from 30° to 120° and wherein the second scalloping extends over an angular sector that ranges approximately from 240° to 330°.

7. Aircraft that comprises at least one propulsion unit according to claim 1.
